(19) United States
(12) Patent Application Publication
(10) Pub. No.: US 2022/0185996 A1
(43) Pub. Date: Jun. 16, 2022

(54) ENVIRONMENTALLY FRIENDLY PRODUCTS

(71) Applicant: LIA DIAGNOSTICS, INC., Philadelphia, PA (US)

(72) Inventors: Anna COUTURIER, Philadelphia, PA (US); Riley STANFORD, Philadelphia, PA (US)

(73) Assignee: LIA DIAGNOSTICS, INC., Philadelphia, PA (US)

(21) Appl. No.: 17/436,569

(22) PCT Filed: Mar. 4, 2020
(86) PCT No.: PCT/US2020/021036

§ 371 Date: Sep. 3, 2021

Related U.S. Application Data
(60) Provisional application No. 62/813,619, filed on Mar. 4, 2019.

(51) Int. Cl. C08L 5/00; C08L 1/28; C08L 5/12; C08J 5/18

(52) U.S. Cl. CPC C08L 5/00; C08L 1/286; C08L 5/12; C08J 5/18; C08J 2305/00; C08L 2203/16; C08L 2201/54; C08J 2301/28; C08J 2305/12; C08L 2201/10

(57) ABSTRACT

The present disclosure relates to optically transparent plant-derived products that are capable of dissolution in water.

### CROSS-REFERENCE TO RELATED APPLICATIONS

The present application claims priority to U.S. provisional patent application No. 62/813,619, filed on Mar. 4, 2019. The content of that application is incorporated herein by reference in its entirety.

### BACKGROUND

Landfill waste associated with single-use products continues to on the rise despite increase awareness of the detrimental effects it has on the environment. For example, plastic comprised over 26 million tons of landfill waste in 2015. The solutions presented herein address these and other needs in the art.

### SUMMARY

In certain frequent embodiments, a formulation is provided for forming an optically transparent product, often comprising a film, a pellet, a filament or other stable composition, comprising a gum (e.g., hydrocolloid contemplated herein), water, and a drying agent. Often, the formulation comprises a solution of between about 3% to about 23% w/w of the gum and the drying agent in the water. In related frequent embodiments, a product is formed from the formulation. Often, the product is flexible. Also often, the flexible product is rollable such that a length of the product can be rolled around a central axis and then unrolled while remaining structurally intact. Often the rolling around a central axis involves rolling the product on itself in an overlapping arrangement. In such an overlapping arrangement, in certain embodiments the roll of product often will include a barrier layer between successive layers of the product, and in certain other embodiments the roll of product often will not include a barrier layer between successive layers of the product. In less frequent embodiments, the product is hard or rigid. In frequent embodiments, the product is optically transparent, permitting the passage of at or over 75%, at or over 80%, at or over 85%, at or over 90%, at or over 91%, at or over 92%, at or over 93%, at or over 94%, at or over 95%, at or over 96%, at or over 97%, at or over 98%, at or over 99%, or 100% of visible light therethrough. Methods of producing an optically transparent product are also provided, which include drying the formulation described herein optionally on a surface, e.g., often a glass, flat stone, nonreactive metal, ceramic, or plastic surface. Frequently the surface is flat or curved, and may frequently comprise a mold to shape the product into a predetermined shape. Often, the drying comprises elevated temperatures optionally with reduced humidity for a predetermined period of time. According to the presently contemplated formulations, the gum is plant-derived, natural, vegan, or non-animal derived. Also, in the most frequently contemplated embodiments, the formulation is plant-derived, natural, vegan, or non-animal derived. Often, in practice, the product comprises a water exposure tolerance of between at or about 5 minutes to at or about 20 minutes. Frequently, the product comprises a water exposure tolerance of at least 10 minutes. In certain embodiments, the product is formed into a lens.

Product rolls (e.g., film rolls) and their methods of production are also contemplated, including those with or without a barrier layer positioned between each successive layer of product. Barrier layers often comprise materials noted herein. In certain related embodiments, methods of manufacture items using products of the present disclosure are contemplated. Such methods involve, among other steps and methods, unrolling the product in the form of a film, measuring a portion or length of the film to a predetermined specification, and cutting a portion of the film from the contiguous film roll. Often die cutting is used to cut the film. The cut portion is generally separated from the contiguous roll though known means, particularly those used in automated manufacturing processes.

Also contemplated herein are products treated or otherwise contacted with a temporary hydrophobic coating reagent and methods of manufacture and use thereof. Such temporary hydrophobic coating reagents include, for example, a reagent containing a hydrophobic nanoparticle. Often the hydrophobic coating reagent is optically transparent when present in dry form on the product.

Also provided herein are embodiments wherein the product is at least one physically contiguous film, and each one of the at least one physically contiguous film(s) remains intact at the end of the water exposure tolerance time. Intact here refers to holes, cracks, breaks, in the contiguous film. Often, the product is at least one physically contiguous film, and each one of the at least one physically contiguous film(s) maintains at least 90% of its original optical clarity, structural rigidity, and/or phase consistency at the end of the water exposure tolerance time. In certain related embodiments, the product is at least one physically contiguous film, and each one of the at least one physically contiguous film(s) maintains at least 99% of its original optical clarity, structural rigidity, and/or phase consistency at the end of the water exposure tolerance time. In certain often included embodiments, the product is at least one physically contiguous film, and each one of the at least one physically contiguous film(s) maintains between at or about 90% to at or about 99% of its original optical clarity, structural rigidity, and/or phase consistency at the end of the water exposure tolerance time. In other often included embodiments, the product is at least one physically contiguous film, and each one of the at least one physically contiguous film(s) maintains between at or about 85% to at or about 95% of its original optical clarity, structural rigidity, and/or phase consistency at the end of the water exposure tolerance time.

Often according to the present disclosure are included products noted herein above and below where the product is a rehydratable product that is adapted to dissolve to fragment sizes of smaller than at or about 1 mm in diameter after one hour treatment in a slosh box or exposure to moving water. Also often, the product is a rehydratable product that is adapted to dissolve to fragment sizes of smaller than at or about 1 mm in diameter in under or about one hour treatment in a slosh box or under or about one hour exposure to moving water. In similar embodiments, often according to the present disclosure are included products noted herein above and below where the product is a rehydratable product that is adapted to dissolve to fragment sizes of between at or about 0.2 mm to at or about 1 mm in diameter after one hour treatment in a slosh box or exposure to moving water. Also often, the product is a rehydratable product that is adapted to dissolve to fragment sizes of between at or about 0.2 mm to at or about 1 mm in diameter in under or about one hour treatment in a slosh box or under or about one hour exposure to moving water. In similar embodiments, often according to the present disclosure are included products noted herein above and below where the product is a rehydratable product that is adapted to dissolve to fragment sizes of between at or about 0.5 mm to at or about 1.0 mm in diameter after one hour treatment in a slosh box or exposure to moving water. Also often, the product is a rehydratable product that is adapted to dissolve to fragment sizes of between at or about 0.5 mm to at or about 1.0 mm in diameter in under or about one hour treatment in a slosh box or under or about one hour exposure to moving water. Often according to the present disclosure are included products noted herein above and below where the product is a rehydratable product that is adapted to dissolve to fragment sizes of smaller than at or about 2 mm in diameter after one hour treatment in a slosh box or exposure to moving water. Also often, the product is a rehydratable product that is adapted to dissolve to fragment sizes of smaller than at or about 2 mm in diameter in under or about one hour treatment in a slosh box or under or about one hour exposure to moving water.

These and other embodiments, features, and advantages will become apparent to those skilled in the art when taken with reference to the following more detailed description of various exemplary embodiments of the present disclosure.

### BRIEF DESCRIPTION OF THE DRAWINGS

The skilled person in the art will understand that the drawings, described below, are for illustration purposes only.

FIG. 1 depicts the results of slosh box testing of exemplary products in comparison to existing collagen-based products.

FIG. 2 depicts the results of additional slosh box testing of exemplary products in comparison to existing collagen-based products.

FIG. 3 depicts examples of film product of the present disclosure at the time of contact with applied water and after incubation with applied water.

### DETAILED DESCRIPTION OF THE VARIOUS EMBODIMENTS

For clarity of disclosure, and not by way of limitation, the detailed description of the various embodiments is divided into certain subsections that follow.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, “a” or “an” means “at least one” or “one or more.”

As used herein, the term “and/or” may mean “and,” it may mean “or,” it may mean “exclusive-or,” it may mean “one,” it may mean “some, but not all,” it may mean “neither,” and/or it may mean “both.”

As used herein, “drying agent” refers to an agent or reagent used in a drying process. As such, drying agents may be reagents that decrease, accelerate, or otherwise affect drying of a material, substance or mixture. Also, a drying agent of the present disclosure often aids in the drying process such that dried materials such as presently contemplated films retain a moisture in their dried stated such that they are not overly rigid and brittle or fragile, but instead have flexibility. Often, this level of moisture is a predetermined level of moisture. Non-limiting examples of certain drying agents contemplated herein, include, for exemplary purposes only, glycerol, glycerine (i.e., vegetable glycerin), sugar alcohol, epichlorohydrin, solketal, sugar, other plant oleochemicals. Unless specifically indicated, such examples are intended to be representative of the larger genus encompassing each exemplary drying agent.

As used herein, the term “soluble” has a conventional meaning. In other words, “soluble” refers to the ability of a specified material to dissolve in another substance such as water, a fluid sample, or another fluid.

As used herein, “biodegradable” refers to a material that is capable of being decomposed by bacteria or other living organisms, natural processes, or other biological agents or means. A biodegradable material may also be water dispersible.

As used herein, “flushable” refers to materials that pass the flushablity guidelines of Association of the Nonwoven Fabrics Industry (INDA), International Water Services Flushability Group (IWSFG), and/or European Disposables and Nonwovens Association (EDANA). Such guidelines are, for example, as set forth in “Guidelines for Assessing the Flushability of Disposable Nonwoven Products,” Fourth Edition, May 2018 (or current edition/guidelines), INDA, IWSFG, and/or EDANA, or another current industry accepted flushability standard, guideline, recommendation, requirement, or objective.

While such guidelines flushablity guidelines of INDA, IWSFG, and/or EDANA refer to a specific toilet flushability standard, their use and reference herein are intended to be broader. The products of the present disclosure may be flushable, but they also may be never intended to be flushed. As such, as contemplated, rehydration standards for products of the products are often based on flushability guidelines of INDA, IWSFG, and/or EDANA while the product itself and its use and/or disposal may be completely independent of possible disposal in a toilet or flushing. Therefore, reference to flushability guidelines of INDA, IWSFG, and/or EDANA herein refers merely to standards used to evaluate the breakdown of a product into smaller constituent components via rehydration. For clarity, these smaller constituent components are produced after passage past the water/liquid exposure tolerance of the presently contemplated products. These standards referring to rehydration standards may alternatively be referred to, for purposes of the present disclosure only, as water dispersibility standards.

As used herein, “rigid” refers to a characteristic of a material to have an ability to hold form without deformation, bending, creasing or otherwise being forced out of shape. A rigid material may be formable such that can be manipulated to form a shape (e.g., when wetted) and this shape is resistant to deformation under certain conditions (e.g., when dried). A rigid material may have some low degree of flexibility over a given length, depending on the applied force. A rigid material may have varying degrees of rigidity.

As used herein, “flexible” or “flexibility” refers to a characteristic of a material to have an ability to deform or bend in response to a physical stimulus without fracturing. Such materials may include compliant materials capable of conforming to a predetermined shape. In general, flexibility does not refer to shape memory or tensile strength, though it encompasses such materials such that a flexible material contemplated herein may have a shape memory and a tensile strength. Also in general, the physical stimulus required to bend a flexible material contemplated herein is mild and dependent on the size and use of the materials contemplated herein.

Other features and advantages of the disclosure will be apparent from the following description. The present innovations are often further described by exemplary embodiments. The examples are provided solely to illustrate the innovations by reference to specific embodiments. These exemplifications, while illustrating certain specific aspects of the innovations, do not portray the limitations or circumscribe the scope of the disclosed innovations. The detailed description illustrates by way of example and is not intended to limit the scope of the present disclosure.

Clear non-plastic films, pellets, filaments, lenses, or other stable compositions that are optically transparent, or may be come optically transparent through or during further processing, are provided as the present products. Such films, pellets, filaments, lenses, or other stable compositions are referred to herein as a product or products. Natural products that are optically transparent are provided. Non-gelatin products that are optically transparent are provided. Vegan products that are optically transparent are provided. In each embodiment, the product is optionally adapted for manufacture. Related to each embodiment, or comprising their own embodiments, a formulation utilized to prepare an exemplary such products are provided. In certain embodiments, methods of adapting a formulation for manufacture are provided. Generally, films of the present disclosure are physically intact and contiguous sheets, lacking cracks, breaks or holes.

As used herein, the term “manufacture” refers to a process that utilizes machinery and is not primarily manual in nature or have more manual steps or process than automated steps/processes.

As used herein, “optically transparent” refers to a non-opaque state. As such, a material described herein that is optically transparent permits the passage of light therethrough. In certain frequent embodiments, an optically transparent product described herein provides for high visual acuity or high clarity therethrough such that small details can be identified beyond the composition when viewing the composition. Also, in certain frequent embodiments, an optically transparent products described herein is a clear product providing a visual acuity therethrough similar to, or identical to, glass.

As used herein, “optically clear” refers to optically transparent permitting passage of a very high degree/percentage of passage of visible light. Often this degree/percentage is at or over 90%, at or over 91%, at or over 92%, at or over 93%, at or over 94%, at or over 95%, at or over 96%, at or over 97%, at or over 98%, at or over 99%, or 100% of visible light.

As used herein “product” or “products” refers to the end intended result of a formulation and/or manufacturing process, which process includes a drying or water/moisture extraction step. The formulation that is used to create the product may have one or more intermediate states, which may be temporary/transitory or have a known length of time, prior to the creation of the product. Often, such product is in the form of a film.

In certain other embodiments, an optically transparent product described herein provides magnification of an image of something viewed therethrough. In such embodiments, the product may be formed into a lens that provides a known or predetermined magnification of an image within a known focal length. A mold providing a desired lens geometry may be utilized in such circumstances to form the formulation into a lens when dried. In practice, a formulation is introduced to the mold and permitted to dry to form the lens. Optionally, two or more molds are used in the formation of a product to act as a lens. In such embodiments, the lens is adapted to provide for a 1.5×, 2×, 2.5, 3×, 3.5×, 4×, 4.5×, 5×, 6×, 7×, 8×, 9×, 10× or greater magnification of an image.

The presently contemplated products are dry, though may optionally have surface tackiness, and have structural integrity such that they can be suspended as a contiguous sheet over an opening between two supports without bending or breaking.

In certain less frequent embodiments, the presently contemplated products are hard and/or stiff. In frequent embodiments, the presently contemplated products are not hard and/or stiff. Rather, the most frequent products retain some level of flexibility. While the characteristic of flexibility is often useful in the context of mass manufacturing the presently contemplated products and also fitting such products into other products in an automated manner, often a level of stiffness is required or preferred to fit the specific use profile and specifications of the product (e.g., as a transparent window/cover/shield on a water dispersible, flushable, biodegradable, compostable device or item). As such, while the term “flexibility” is used herein, it is not intended to be mutually exclusive such that a flexible product contemplated herein may also often have a predetermined level of stiffness prior to flexing and/or at specific environmental conditions. Often the size of the product or physical placement of the product on an downstream device or item will have an effect on the perceived stiffness and/or flexibility of the product.

Frequently, the presently contemplated products are flexible after produced and dried, such as a flexible film. Also often, the flexible product/film is rollable such that a length of the product/film can be rolled around a central axis and then unrolled while remaining structurally intact. Often the rolling around a central axis (or one or more central axes) involves rolling the product/film on itself in an overlapping arrangement. In such an overlapping arrangement, in certain embodiments the roll of product/film often will include a barrier layer between successive layers of the product, and in certain other embodiments the roll of product often will not include a barrier layer between successive layers of the product. A barrier layer may be a separate film that inhibits successive layers of the film from sticking, adhering, or otherwise bonding while rolled. A barrier layer may be contacted and rolled together with the product/film after drying, and unrolled and separated from the product/film when the product/film is unrolled for use or another purpose. Contemplated barrier layers include plastic, parchment, foil, or other layer.

In general, the presently contemplated products and/or formulations are comprised of non-animal and/or non-animal derived material. For example, animal-based gelatin does not form an aspect of the presently contemplated products and/or formulations. In certain embodiments the presently contemplated products and formulations are plant-based. Often, the presently contemplated products or formulations are comprised of a natural gum, a plant-derived gum, a non-animal gum, or an otherwise naturally-derived gum.

The presently contemplated products may be provided in a variety of thicknesses. For example, in certain embodiments the product is prepared as a film between at or about 0.03 mm to at or about 0.15 mm. Frequently, the thickness of the film is between at or about 0.06 mm to at or about 0.08 mm. Often, the thickness of the film is at or about 0.07 mm. In certain embodiments, the product is prepared as a film between at or about 0.06 mm to at or about 1.0 mm. In certain embodiments, the product is prepared as a film between at or about 0.1 mm to at or about 0.5 mm. In certain embodiments, the product is prepared as a film between at or about 0.5 mm to at or about 1.0 mm. In certain embodiments, the product is prepared as a film between at or about 0.05 mm to at or about 0.1 mm. In certain embodiments, the product is prepared as a film between at or about 0.05 mm to at or about 0.2 mm. In certain embodiments, the product is prepared as a film between at or about 0.05 mm to at or about 0.3 mm. In certain embodiments, the product is prepared as a film between at or about 0.05 mm to at or about 0.5 mm. In certain embodiments, the product is prepared as a film between at or about 0.05 mm to at or about 0.5 mm, to at or about 0.6 mm, to at or about 0.7 mm, to at or about 0.9 mm, or to at or about 1.0 mm.

Product film thickness is often calculated with knowledge of the solid composition of the product when wet, such as a wet film. The solid content added to water comprises a percentage of the total weight of the solution, and this yields a “percent solids” value. The thickness of the wet film (e.g., measured in millimeters) multiplied by the percent solids (unitless) yields the final dry film thickness (e.g., measured in millimeters). The ideal thickness of the film is often around about 0.5 mm, though this value can be adjusted as contemplated herein based on manufacturing capabilities or parameters, and/or formulation adjustments.

It is contemplated that the formulations described herein are formed into a variety of physical orientations, formats, and/or products, including films, pellets, filaments, lenses, or other stable compositions. Unless specifically defined, a “product” or dried formulation product refers to the films, pellets, filaments, lenses, or other stable compositions described herein. Often, a mold is utilized to provide a pre-determined shaping of the product after the drying process. In practice, a formulation is introduced to the mold and the formulation is dried to form the product such as a lens. Optionally, two or more molds are used in the formation of a material to act as a lens. In certain embodiments, a pellet is formed for use in further processing such as a further molding process, including injection molding.

The present formulations and products prepared therefrom are often reversible. In this regard, according to frequent embodiments provided herein, a product may be hydrated to form at least a partial or entire fluid mixture or solution of the formulation, and then re-dried.

In certain frequent embodiments, the presently contemplated products or formulations are comprised of a hydrocolloid. Gum is one of the most frequent hydrocolloids contemplated herein, though other hydrocolloids are specifically contemplated. In certain other frequent embodiments, the presently contemplated products or formulations are comprised of a mixture of two or more different hydrocolloids. Hydrocolloids are hydrophilic polymers, of vegetable, animal, microbial or synthetic origin, that generally contain many hydroxyl groups and may be polyelectrolytes. In general, a hydrocolloid forms a gel when mixed with water. According to a variety of the contemplated embodiments, the products described herein are created with a hydrocolloid powder, which is dissolved in water and dried over a smooth surface. Impurities in the thick and viscous solution such as air bubbles and undissolved hydrocolloid powder are often to be avoided, to ensure heightened visual clarity. The term ‘hydrocolloid’ refers to a substance with particle sizes between ten nanometers and ten micrometers that can occupy different states of matter. The types of colloids include aerosols, foams, emulsions, and suspensions. Suspensions are defined as solid particles in a liquid. A glassy state occurs when a more amorphous colloidal paste is set down to dry. In the glassy state, the molecular distribution looks closer to a very dense liquid than a solid. Cellulose gum comprises a particularly preferred hydrocolloid according to the embodiments of the present disclosure. While not being intended to be bound by the manner of production, as noted herein often cellulose gum of the embodiments contemplated herein is produced from cellulose suspended in alkali and reacted with sodium monochloroacetate to create carboxymethyl cellulose.

In certain embodiments, the presently contemplated products are utilized in roll-to-roll manufacture of film product. In certain related embodiments, the presently contemplated products may be manufactured into and/or stored in roll format. Often the product is produced as a film and rolled for storage, transport, or downstream manufacturing purposes. When the product is provided in a roll format, the product is often unrolled and cut to pre-determined specifications for use in manufacturing operations, such as fabricating items that utilize the product. Die cutting is often used to cut pieces of the product or section portions or lengths thereof when the product is utilized in an automated manufacturing process. In this manner the product may be unrolled and cut to a predetermined specification. Such cutting may be while the product is stationary or moving.

Exemplary embodiments of products described herein are clear, water dispersible, biodegradable, and withstand water exposure for at least five minutes, or at least ten minutes, or at least fifteen minutes, or up to about twenty minutes (water exposure tolerance). In this sense, the phrase “water exposure tolerance” is intended to encompass exposure to any variety of liquids that include H₂O as a component and refers to a rehydration process of the product. In certain other embodiments, exemplary products described herein are clear, water dispersible, biodegradable, withstand water exposure for at least ten minutes, and are plant based. Often the water exposure tolerance of the present products is between 5 minutes to 15 minutes. Also often, the water exposure tolerance of the present products is between 10 minutes to 20 minutes. As discussed herein, when water exposure tolerances are described it is intended to refer to maintenance of the integrity of the product for its original purpose. When a tolerance is exceeded, the product has begun to degrade from this standard or has degraded below that standard as part of the rehydration process. Unless specifically indicated otherwise, this standard generally refers to herein in connection with optical clarity, structural rigidity, phase consistency, etc. of the product. While not intending to be bound by any specific theory of operation, in one example, the product is exposed to a fluid (e.g., water) and begins to absorb water and rehydrate or dissolve (together or individually referred to herein as rehydration) after about a predetermined or known time period. In another example, the product is exposed to a fluid (e.g., water) and constituents of the product begin to enter solution or a liquid phase after about a predetermined or known time period. While water is specifically mentioned in the surrounding sections, it is for ease of explanation only and other liquids (acidic, basic, etc. across an extended range of pH) are specifically contemplated and encompassed within the recited parameters as a liquid exposure tolerance. Liquid exposure tolerance refers to exposure to any liquid whether or not it includes H₂O as a component.

Also, in another example, the product is exposed to a fluid (e.g., water) and the product rigidity begins to deteriorate, whereby the product begins to bow, bulge, bowl, break, crack, bend, etc. after about a predetermined or known time period such as a water exposure tolerance time or rating. In such circumstances the time period is often between about 10 minutes to 20 minutes. In certain examples the time period is over 5 minutes. It is contemplated that the fluid exposure may comprise fluid at or between ambient temperature, room temperature and body temperature (e.g., 98.6° F.) or another temperature. At cooler temperatures, the water exposure tolerance may often be extended in duration. At higher temperatures, the water exposure tolerance may often be reduced in duration. After the predetermined or known time, often the product will rehydrate, dissolve or disperse in a variety of temperatures of liquids, including cold or room temperature liquids.

While water is discussed as a primary vehicle for measurement of liquid integrity of the products contemplated herein, it is for convenience only. It is contemplated that acidic and/or basic liquids or solutions may be utilized in breaking down the products contemplated herein. In certain examples, a liquid having a pH at, below or above 7.0 is contacted with a product contemplated herein and either begins, finishes or carries out the full rehydration, dissolution or dispersion of the products contemplated herein.

The discussion above regarding exposure of the product to liquid and liquid/water exposure tolerances contemplates exposure under still or physically agitated conditions. While not intending to be bound by any specific theory of operation, in certain embodiments when the product is agitated along with the exposure to liquid, the integrity of the product is decreased relative to identical exposure when non-agitated.

In certain embodiments, the product is exposed to liquid and the rehydration process involves contact of the product with a liquid, which begins the rehydration process. In certain embodiments, the product is exposed to liquid and the rehydration process involves immersion of the product within a liquid, which begins the rehydration process. In certain embodiments, the product is exposed to liquid and the rehydration process involves contact of the product with a liquid and then immersion of the product in a liquid, the contact and immersion liquids optionally being identical or different. In certain embodiments, the product is coated with a temporary hydrophobic coating that lengthens the eater/liquid exposure tolerance of the product. Such contemplated temporary hydrophobic coatings may be, for example, those set forth in U.S. application Ser. No. 16/318,097, filed Jan. 15, 2019, entitled “TEMPORARY HYDROPHOBIC MATRIX MATERIAL TREATMENTS, MATERIALS, KITS, AND METHODS,” which is encompassed herein by reference in its entirety. A preferred temporary hydrophobic coating is optically transparent or clear when coated on the present products. A temporary hydrophobic coating is optionally included with any embodiment contemplated herein. Such coating is applied after the product is subjected to a drying process or concurrently therewith.

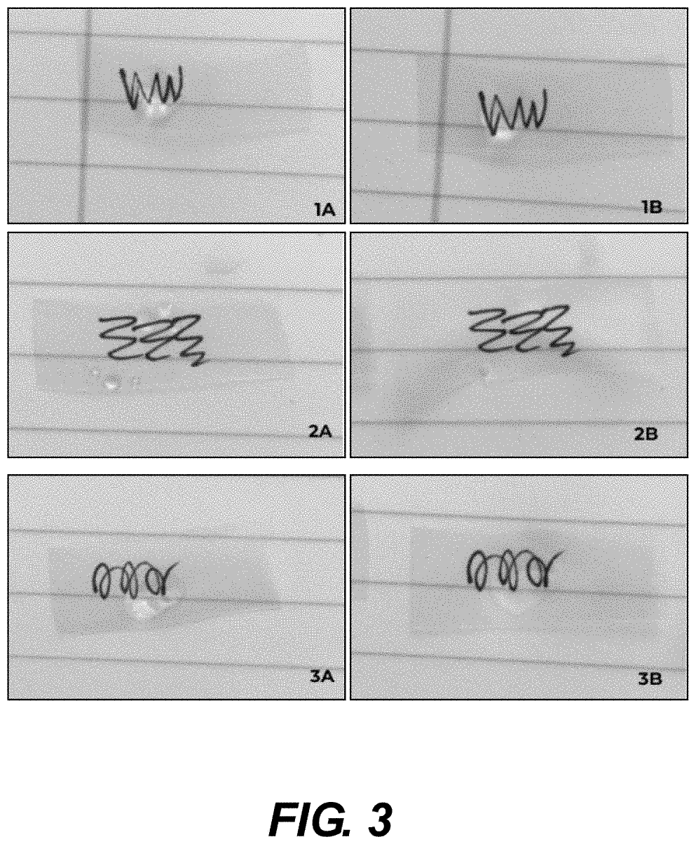

In order to determine the effectiveness of products films of the present disclosure, the capability to withstand accidental water exposure was evaluated. In such testing body-temperature water as applied to the film. The film was placed over a sheet of notebook paper with some ink shapes on it, to determine if the image would be significantly distorted after water exposure. The water was dropped onto the film and photographed immediately after. Then, after ten minutes, the film was photographed again. Some examples of this are shown in FIG. 3. Evaluations 1-3 are depicted, with the “A” portion on the left (i.e., 1A, 2A, and 3A) representing images of the product immediately after contact with water. The “B” portion on the right (i.e., 1B, 2B, and 3B) represent images of the product 10 minutes after contact with water. The post contact product remains to be optically transparent, though rehydration of the product was underway with the integrity of the product degrading. Film thickness variation affects these results. Thinner films are more likely to lose their integrity sooner than thicker films, as water permeates the film.

In certain frequent embodiments contemplated herein, an exemplary product is used as a barrier, window, or housing component for a diagnostic assay. Often, such products are used to protect at least one aspect of a diagnostic assay from pre-mature fluid exposure, cross-contamination, or misdirected fluid entry to the assay. As such, products contemplated herein often have structural and optical integrity such that they withstand manufacture, cutting and fitting with a diagnostic device or assay, shipping, storage, and/or use prior to degradation (e.g., dispersed in water).

It is contemplated according to the present disclosure that the exemplary products have a predetermined time for withstanding exposure to water (or a sample fluid) and then break down after that predetermined time. It is contemplated according to the present disclosure that the exemplary products are flushable after a predetermined time.

It is contemplated according to the present disclosure that the exemplary products are biodegradable, for example, after about ten weeks. In certain related embodiments, the exemplary products are biodegradable for example, after about 15, 20, 25, 30, or more weeks.

The contemplated products are prepared using one or more hydrocolloid powder dissolved in a diluent (e.g., water), and then dried (e.g., over a smooth surface). Steps of mixing the hydrocolloid powder and optionally poring the resulting solution into a mold or location for drying are similarly contemplated. A colloid is a substance with particle sizes between ten nanometers and ten micrometers that can occupy different states of matter. Aerosols, foams, emulsions, and suspensions are types of colloids. See Hunter & Weeks, Reports on Progress in Physics, 75, 2012. A suspension has been referred to as solid particles in a liquid. See id. In such a suspension, a glassy state is present through the drying phase of an amorphous colloidal paste. See id. In such a glassy state, the molecular distribution appears similar to a very dense liquid. A hydrocolloid is a substance that forms a gel when mixed with water.

According to the present disclosure, a hydrocolloid powder is dissolved in solution (e.g., water) over heat. Whereby it dissolves into a liquid state and passes through a glassy phase transition as moisture escapes. The resulting gel solution in exemplary embodiments is thick and viscous, and drying is required to further convert the gel into a more crystalline structure. Whereupon the gel is dried, it forms a flexible product. In frequent embodiments contemplated herein, the colloid comprises agar agar, carrageenan, cellulose gum, and/or xanthum gum powder.

Regarding cellulose gum (i.e., carboxymethyl cellulose (CMC)), it is derived from wood pulp or cotton linters and is modified to have carboxymethyl groups attached to the cellulose molecules. Cellulose alone is found in wood, and has a tight chain structure, with the chains linked closely together. So closely together, in fact, that water cannot get between the chains to bond with the cellulose molecules, and thus, cellulose is water insoluble. To create CMC from cellulose, cellulose is suspended in alkali so that the chains loosen up enough to allow water to enter the chains and reacted with sodium monochloroacetate to create sodium carboxymethyl cellulose. The groups added to the cellulose molecule are spread such that additional bonding is avoided between groups, and moreover due to these additions the modified molecules have space to allow water to enter. Water then integrated between the chains of CMC molecules, which spreads them, making CMC water soluble while cellulose is not. Moreover, CMC maintains relatively high viscosity in aqueous solutions.

The formulations contemplated herein are prepared and dried to form the products similarly contemplated herein. The drying process in a basic form involves basic removal of free water from the formulation. As such, products of the present disclosure may be simply other forms of the formulations contemplated herein, with less or no free water, without having to go through a drying process (e.g., if made using additive manufacture). Nevertheless, in the drying process, elevated temperatures and/or reduced humidity conditions are optionally used to dry the formulation. Chemical drying processes are also contemplated. Drying in ambient conditions is also contemplated. Though not wishing to be bound by any particular theory, the conditions utilized in the drying process have been found to affect the ultimate product optical clarity and product surface formation. It was found that drying on flat surfaces such as glass, which do not permit leeching or transfer of surface impurities to the drying formulation, are preferable. Optional, though less preferable, drying surfaces include stone, plastic, metal and paper. It was also found that when using elevated temperatures, surfaces that maintain their surface integrity during elevated heat application are preferable. In frequent embodiments, the drying surface (or any surface in contact with the formulation or drying formulation) does not permit formation of reactive species such as ionic moieties during the drying process. Flat glass or non-reactive plastic surfaces are often used according to the present methods. It was found that glass was particularly suitable due to its ability to maintain its full integrity under high heat conditions. Formulations dried on glass surfaces, for example, had high optical clarity and product surface uniformity.

In certain preferred embodiments, the contemplated formulations and processes do not include added sugar added prior to or during drying. Adding sugar to the formulation was found to negatively affect visual acuity of the dried product.

Often in such embodiments, the formulation used to produce the contemplated products is applied to a drying surface and permitted to dry, e.g., at elevated temperature and low humidity. Drying agents are often utilized to promote evenness of the formulation while free water evaporates from the formulation during drying. This is particularly useful in applications utilized high heat to promote formulation integrity, uniformity, and/or optical consistency of the dried product. Additives such as glycerol, glycerine (i.e., vegetable glycerin), sugar alcohol, epichlorohydrin, solketal, sugar, other plant oleochemicals, etc. are often included in product formulations as drying agents, for example, to promote evenness in drying under elevated heat conditions in reduced humidity (e.g., dry oven heat). Exemplary formulations include a mixture of a gum, water and a drying agent. Exemplary drying conditions include ambient temperature, and often range between 140° F. to 300° F. In certain frequent embodiments, the drying temperature was between about 200° to about 300° F. When using elevated temperatures, the time permitted for drying ranges up to several hours, but it often much less. For example, in certain contemplated embodiments, the drying time is between 30 minutes and 2 hours. In certain embodiments, the drying time is between about 30 minutes to one hour. Exemplary formulations include the mixture of between about 3% to about 23% w/w of gum with drying agent in a solution of water. Often the formulation comprised a mixture of between about 3% to 5% or 10% w/w of gum with drying agent in a solution of water. The relative concentration of the gum with drying agent in such formulations often varies between 100% to 50%. The gum was selected from a hydrocolloid such as CMC, agar agar, carrageenan, and/or xanthum gum. The concentration of the ingredients in the produced and dried product vary based on the residual level of water content in the dried product. In one exemplary embodiment, a solution used to produce an exemplary product is comprised of about 96% water, about 3% gum and about 1% glycerine. In another exemplary embodiment, a solution used to produce an exemplary product is comprised of about 97% water, about 2% gum and about 1% glycerine. In another exemplary embodiment, a solution used to produce an exemplary product is comprised of about 95% water, about 4% gum and about 1% glycerine. In another exemplary embodiment, a solution used to produce an exemplary product is comprised of about 95% water, about 3% gum and about 2% glycerine. In another exemplary embodiment, a solution used to produce an exemplary product is comprised of about 97.5% water, about 2% gum and about 0.5% glycerine.

In certain other embodiments, a gum is utilized in a 3D printing or additive manufacture process to form a product contemplated herein. In such embodiments, a product comprising a dried product of a formulation described herein may be utilized in such 3D printing or additive manufacture process. In other embodiments, a gum powder (e.g., colloid powder such as CMC powder) is used in an additive manufacture process to form a product contemplated herein.

Rehydration metrics were conducted, for example, with plate sieves, an orbital shaker, and a clear bin to fill with a specified amount of water. In such examples, samples of product were cut into 6.25 square inch sections measuring 2.50 inches on each side. Immediately before placement into the slosh box, the mass of the sample was recorded. Sieves plates having multiple different pore sizes were employed. The orbital shaker was initiated and calibrated to a predetermined number of rotations per minute (dictated by, for example an INDA, IWSFG, and/or EDANA standard. A predetermined amount of water was introduced to in a two-liter beaker at a temperature of 72T (s.d. of +/−2T). The measured water was then introduced to the clear bin (this one measuring eighteen by twelve inches with a depth of five inches). The samples of product were introduced to the clear bin before or after introduction of the water. After a predetermined amount of time for each evaluation (here, one hour), the contents of the box having the rehydrating product samples were poured through the sieve into a two-liter beaker. Any trapped remnants of product sample were drained for about two minutes before being placed on an optionally flat drying surface. For optimal drying, the remnants were separated out and laid as flat as possible for drying overnight (or another suitable method). When the material was fully dried and brittle, the scraps were collected and weighed. The entirety of the dry mass of the product was found to rehydrate/dissolve, leaving no remnants in a 1 mm sieve.

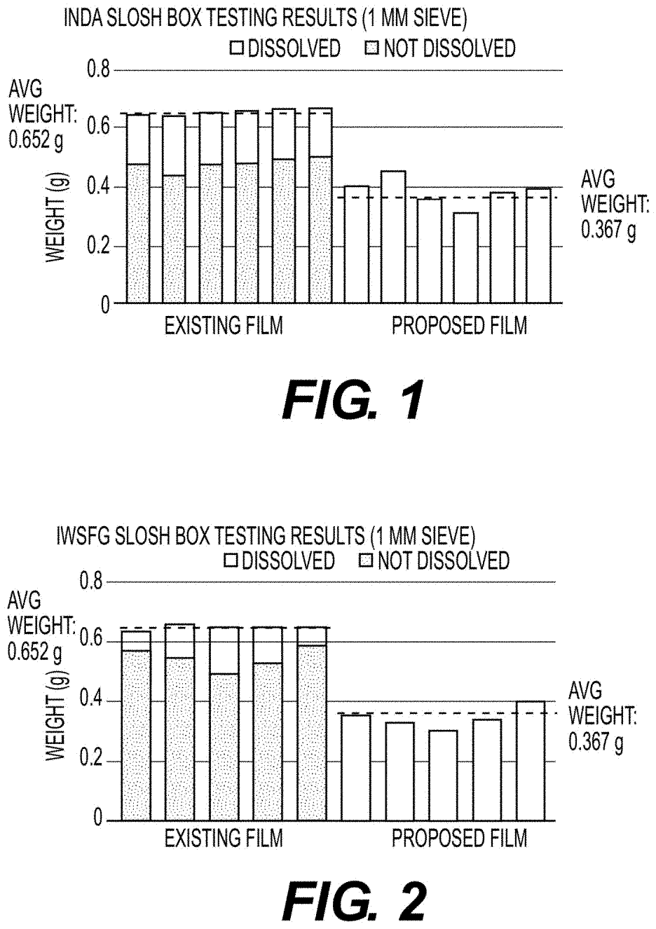

The results of the slosh box tests are shown in FIGS. 1 & 2, with data provided in the following Tables.

TABLE 1
Table 1: IWSFG slosh box test results of presently contemplated products

| | Sample 1 | Sample 2 | Sample 3 | Sample 4 | Sample 5 |
|---|---|---|---|---|---|
| Initial Dry Weight (g) | 0.355 | 0.327 | 0.302 | 0.340 | 0.404 |
| Weighed Scraps (g) | 0.00 | 0.00 | 0.00 | 0.00 | 0.00 |
| Percent Disintegration | 100 | 100 | 100 | 100 | 100 |

TABLE 2
Table 2: IWSFG slosh box test results of collagen-based film

| | Sample 1 | Sample 2 | Sample 3 | Sample 4 | Sample 5 |
|---|---|---|---|---|---|
| Initial Dry Weight (g) | 0.637 | 0.663 | 0.651 | 0.647 | 0.642 |
| Weighed Scraps (g) | 0.568 | 0.547 | 0.494 | 0.529 | 0.587 |
| Percent Disintegration | 10.8 | 17.5 | 24.1 | 18.2 | 8.57 |

TABLE 3
Table 3: INDA slosh box test results of presently contemplated products

| | Sample 1 | Sample 2 | Sample 3 | Sample 4 | Sample 5 | Sample 6 |
|---|---|---|---|---|---|---|
| Initial Dry Weight (g) | 0.402 | 0.453 | 0.361 | 0.311 | 0.382 | 0.396 |
| Weighed Scraps (g) | 0.00 | 0.00 | 0.00 | 0.00 | 0.00 | 0.00 |
| Percent Disintegration | 100 | 100 | 100 | 100 | 100 | 100 |

TABLE 4
Table 4: INDA slosh box test results of collagen-based film

| | Sample 1 | Sample 2 | Sample 3 | Sample 4 | Sample 5 | Sample 6 |
|---|---|---|---|---|---|---|
| Initial Dry Weight (g) | 0.647 | 0.641 | 0.655 | 0.660 | 0.664 | 0.668 |
| Weighed Scraps (g) | 0.478 | 0.441 | 0.478 | 0.481 | 0.498 | 0.503 |
| Percent Disintegration | 26.1 | 31.2 | 27.0 | 27.1 | 25.0 | 24.7 |

FIG. 1 depicts the results of the IVDA slosh box testing. The 6 columns on the left represent the dissolution of a prior film composed of collagen-based film, and the 6 columns on the right represent films of the presently contemplated products, which break down into pieces smaller than 1 mm.

FIG. 2 depicts the results of the IWSFG slosh box testing. The 5 columns on the left represent the dissolution of a prior film composed of collagen-based film, and the 5 columns on the right represent films of the presently contemplated products, which break down into pieces smaller than 1 mm.

Exemplary products were evaluated for water dispersibility, shelf life, and biodegradability.

The above examples are included for illustrative purposes only and are not intended to limit the scope of the disclosure. Many variations to those methods, systems, and devices described above are possible. Since modifications and variations to the examples described above will be apparent to those of skill in this art, it is intended that this invention be limited only by the scope of the appended claims.

One skilled in the art will appreciate further features and advantages of the presently disclosed methods, systems and devices based on the above-described embodiments. Accordingly, the presently disclosed methods, systems and devices are not to be limited by what has been particularly shown and described, except as indicated by the appended claims. All publications and references cited herein are expressly incorporated herein by reference in their entirety and/or for the specific reason for which they are cited herein.

1. A formulation for forming an optically transparent product, comprising a gum, water, and a drying agent.

2. The formulation of claim 1, wherein the formulation comprises a solution of between about 3% to about 23% w/w of the gum and the drying agent in the water.

3. A product formed from the formulation of claim 1, wherein the product is optically transparent.

4. The product of claim 3, wherein the product is flexible and rollable.

5. The product of claim 3, wherein the product is optically clear.

6. A method of producing an optically transparent product, comprising drying the formulation of claim 1 on a surface to produce the optically transparent product.

7. The method of claim 6, wherein the drying comprises elevated temperatures optionally with reduced humidity for a predetermined period of time.

8. The method of claim 6, wherein the surface is flat or curved.

9. The formulation of claim 1, wherein the gum is plant-derived, natural, vegan, or non-animal derived.

10. The formulation of claim 1, wherein the formulation is plant-derived, natural, vegan, or non-animal derived.

11. The product of claim 3, wherein the product comprises a water exposure tolerance or a liquid exposure tolerance of between at or about 5 minutes to at or about 20 minutes.

12. The product of claim 3, wherein the product comprises a water exposure tolerance or a liquid exposure tolerance of at least 10 minutes.

13. The product of claim 11, wherein the product is at least one physically contiguous film, and wherein each one of the at least one physically contiguous film remains intact at the end of the water exposure tolerance time.

14. The product of claim 11, wherein the product is at least one physically contiguous film, and wherein each one of the at least one physically contiguous film maintains at least 90% of its original optical clarity, structural rigidity, and/or phase consistency at the end of the water exposure tolerance time.

15. The product of claim 3, wherein the product is a rehydratable product that is adapted to dissolve to fragment sizes of smaller than at or about 1 mm in diameter after one hour treatment in a slosh box or exposure to moving water.

16. The product of claim 11, wherein the product is a rehydratable product that is adapted to dissolve to fragment sizes of smaller than at or about 1 mm in diameter in under or about one hour treatment in a slosh box or under or about one hour exposure to moving water.

17. The method of claim 6, wherein the optically transparent product is further treated with a temporary hydrophobic coating reagent.
